(19) United States
(12) Patent Application Publication
(10) Pub. No.: US 2025/0053875 A1
(43) Pub. Date: Feb. 13, 2025

(54) HOMOTOPY EXTRACTION FOR AUTONOMOUS DRIVING USING A MACHINE LEARNING MODEL

(71) Applicant: Motional AD LLC, Boston, MA (US)

(72) Inventors: Thomas Kølbæk Jespersen, Copenhagen (DK); Juraj Kabzan, Boston, MA (US)

(21) Appl. No.: 18/799,403

(22) Filed: Aug. 9, 2024

Related U.S. Application Data
(60) Provisional application No. 63/518,641, filed on Aug. 10, 2023.

(51) Int. Cl. G06N 20/00

(52) U.S. Cl. CPC G06N 20/00

(57) ABSTRACT

Provided are methods for homotopy extraction using a machine learning model, which can include obtaining sensor data and route data and determining homotopy data comprising constraint data, for example, based on sensor data and/or route data. Some methods described also include providing operation data associated with the homotopy data to cause the vehicle to operate based on the constraint data. Systems and computer program products are also provided.

### RELATED APPLICATIONS

Any and all applications for which a foreign or domestic priority claim is identified in the Application Data Sheet as filed with the present application are incorporated by reference under 37 CFR 1.57 and made a part of this specification. This application claims priority to U.S. Prov. App. No. 63/518,641, entitled HOMOTOPY EXTRACTION FOR AUTONOMOUS DRIVING, which was filed on Aug. 10, 2023, and which is incorporated herein by reference in its entirety for all purposes and made part of this specification.

### BRIEF DESCRIPTION OF THE FIGURES

FIG. 1 is an example environment in which a vehicle including one or more components of an autonomous system can be implemented;

FIG. 2 is a diagram of one or more example systems of a vehicle including an autonomous system;

FIG. 3 is a diagram of components of one or more example devices and/or one or more example systems of FIGS. 1 and 2;

FIG. 4A is a diagram of certain components of an example autonomous system;

FIG. 4B is a diagram of an example implementation of a neural network;

FIGS. 4C and 4D are diagrams illustrating example operations of a convolutional neural network (CNN);

FIG. 5 is a diagram of an example implementation of a system for data-driven homotopy extraction;

FIGS. 6A-6B are diagrams of an example implementation of a process for data-driven homotopy extraction;

FIGS. 7A-7B are diagrams different types of parameterized constraints for a particular homotopy;

FIG. 8, is a diagram illustrating an example of an environment for training a machine learning model;

FIG. 9 is a diagram illustrating an example of an environment for training a machine learning model

FIG. 10 is a flow diagram illustrating an example of a method or process for homotopy extraction; and

FIG. 11 is a flowchart of an example process for training a machine learning model for homotopy extraction.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Autonomous vehicles may use homotopies for determining particular trajectories to take during operation. In some cases, autonomous vehicles may extract multiple homotopies, compute candidate trajectories within the homotopies, and choose the “best” trajectory by cost scoring. For example, autonomous vehicles may execute route planning, extract homotopies along the route, find a trajectory realization within each resulting homotopy, score the valid trajectories, and select the “best” one. However, this type of architecture relies on a set of homotopies extracted through an expensive tree search, followed by the constraint generation for each homotopy which includes the addition of manually tuned buffers. In the end, only one trajectory originating from one homotopy is chosen and thus the computation spent on the other homotopies and realizations is wasteful.

In some aspects and/or embodiments, systems, methods, and computer program products described herein include and/or implement homotopy extraction, for example for autonomous driving. In certain implementations, the disclosure provides for a reduced number of homotopies, or only one homotopy, and respective constraints for the reduced number of homotopies. Example techniques use a machine learning (ML)-based approach to predict the selected homotopy and its constraints using specific data inputs. In some examples, a machine learning model can initially be trained (bootstrapped) based on the output of an (oracle) motion planner, and then improved with manually driven data (e.g., data collected during navigation of a vehicle) to imitate human maneuvers.

By virtue of the implementation of systems, methods, and computer program products described herein, techniques can allow using expert trajectories (training data) to improve the homotopies, and do not need to rely on hand-tuned buffers used to construct the soft homotopy constraints. This leads to a better generalization over encountered scenarios, instead of hand-engineered solutions. Moreover, the trained network can save the compute time spent on homotopy extraction and trajectory realization of a large set of homotopies. For example, by using a machine learning model for prediction of the selected homotopy and its constraints, the amount of computational power can be reduced, for example only one homotopy, the selected homotopy, and the constraints are generated. The machine learning model can be trained (e.g., bootstrapped) on the output of various components of the autonomous system, which can save compute time spent on homotopy extraction and trajectory realization of a large set of homotopies. Thereafter, the machine learning model can be improved with manually driven data to imitate human maneuvers, allowed for improved operation of an autonomous vehicle. For example, the machine learning model can be trained to consider expert trajectories to imitate human-like maneuvers with dynamically identified human-like buffers towards other agents, thereby improving operation of the autonomous vehicle. Further, these techniques for data-driven homotopy extraction can extract a homotopy with a greatly optimized computation time, such as a well-defined computation time, because the expensive and/or highly varying computation time during the tree search of the homotopy extraction algorithm can be avoided. In some cases, the manually driven data may correspond to data collected during navigation of various vehicles. For example, the manually driven data may correspond to data collected during navigation of thousands, millions, or move vehicles. In certain cases, the vehicles may be navigated by a person or anonymously.

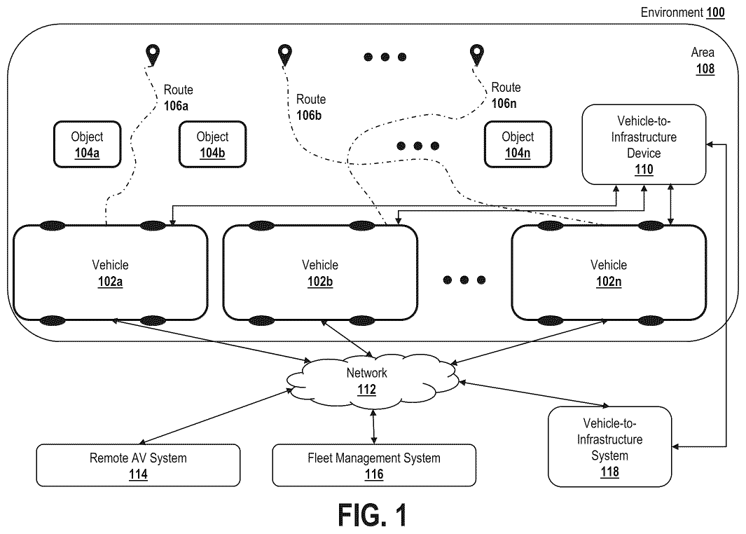

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

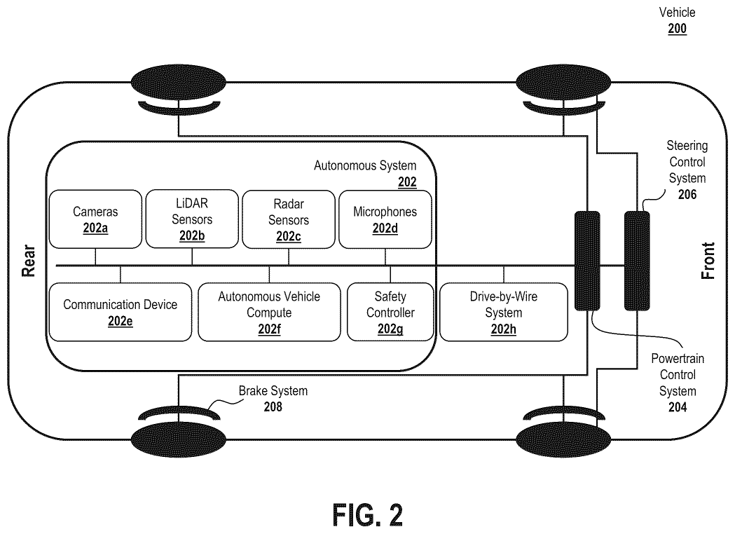

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 includes a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

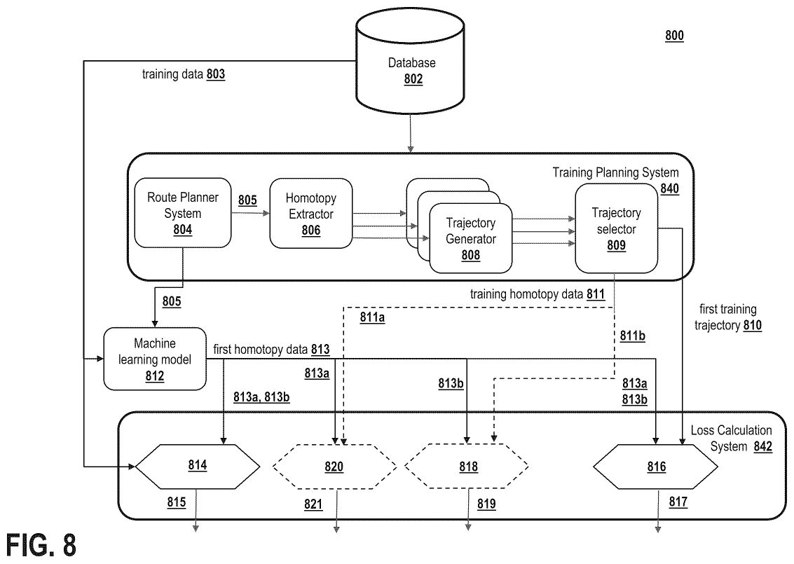

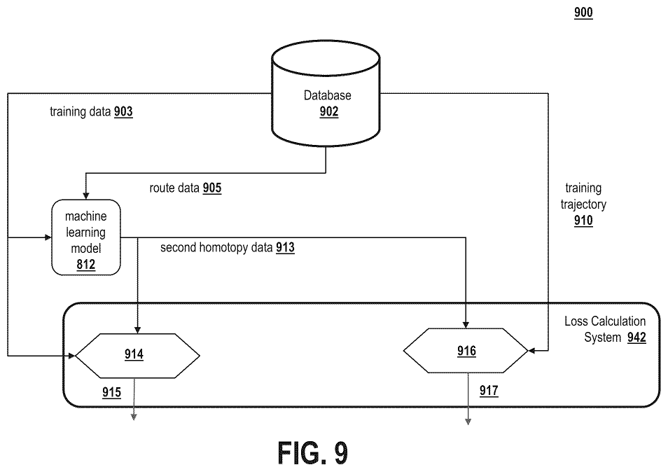

In some embodiments, device 300 is configured to execute software instructions of one or more steps of the disclosed methods, as illustrated in FIG. 8 and/or FIG. 9.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

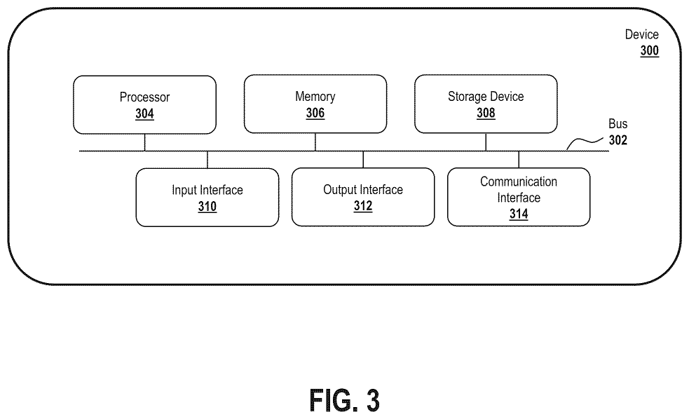

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f includes at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer-readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally, or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi© interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer-readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally, or alternatively, a set of components (e.g., one or more components) of device 300 can perform one or more functions described as being performed by another component or another set of components of device 300.

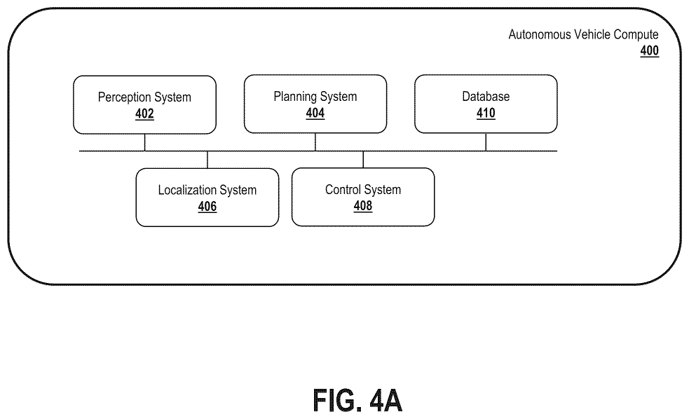

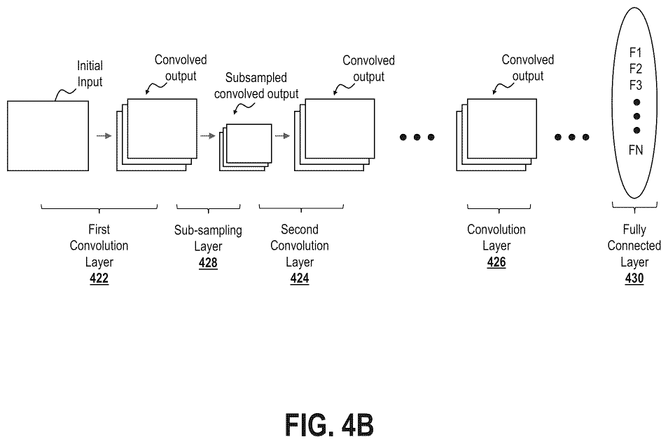

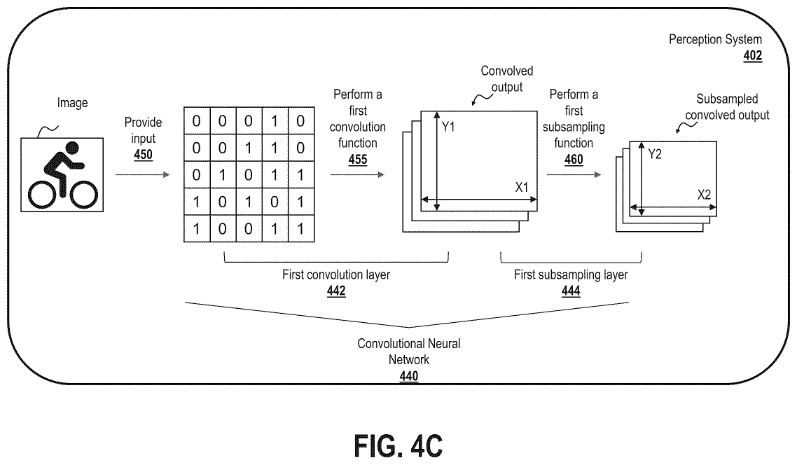

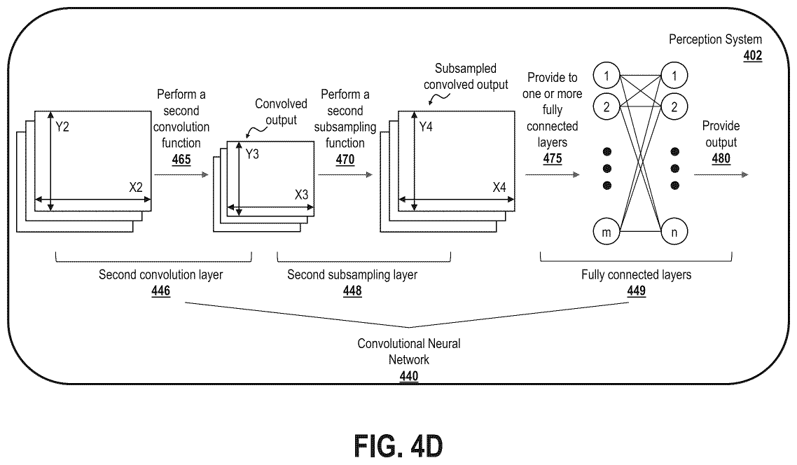

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities for the regulation of the y-axis component of vehicle motion. The longitudinal vehicle motion control causes activities for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

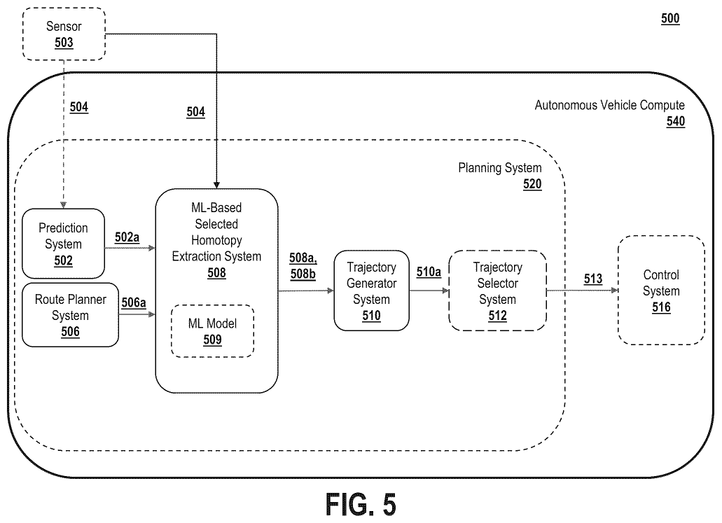

FIG. 5 is a diagram illustrating an example of a system 500 for data-driven homotopy extraction. In some embodiments, one or more components of system 500 are included in (or implemented by) a planning system of an AV compute (e.g., a system that is the same as, or similar to, planning system 404 of AV compute 400). Additionally, or alternatively, one or more components of system 500 are included in (or implemented by) a system different from (or in cooperation with) the planning system of an AV compute. For example, one or more components of system 500 can be included in (or implemented by) a control system (e.g., a system that is the same as, or similar to, control system 408 of AV compute 400), the perception system 402, localization system 406, and/or database 410. In this example, the control system can operate independent of the planning system or in coordination with the planning system. In some embodiments, one or more components of system 500 are included in (or implemented by) one or more systems of vehicle 102, system 114, vehicle 200, and/or AV compute 400, alone or in coordination with one another that are different from, or include, the planning system and the control system.

In one or more embodiments or examples, the system 500 is in communication with one or more of: a device (such as device 300 of FIG. 3), a localization system (such as localization system 406 of FIG. 4A), a planning system 520 (such as the planning system 404 of FIG. 4A), a perception system (such as the perception system 402 of FIG. 4A), and a control system 516 (such as the control system 408 of FIG. 4A).

Disclosed herein is a system 500 for data-driven homotopy extraction for an autonomous vehicle. The system 500 includes at least one processor and at least one non-transitory computer-readable medium storing instructions that, when executed by the processor, cause the processor to perform one or more operations as discussed herein. For example, operations include one or more of obtaining sensor data 504 and obtaining route data 506a. As another example, operations include determining homotopy data 508a including constraint data 508b associated with one or more continuously differentiable parametric constraints based on the sensor data 504 and the route data 506a. In some instances, the operations include providing operation data of a trajectory 513.

In other words, the system 500 can be configured to replace certain typically used route planning systems with the determination of homotopy data, such as by using a machine learning model 509. In some respects, one or more trajectory generator systems 510 are used for generating one or more trajectories 510a. Typical systems have used multiple trajectory generators to generate many trajectories, which greatly increase computational needs. By utilizing ML-based homotopy extraction for determining homotopies, the number of homotopies/trajectories generated (and/or the number of trajectory generator systems 510) may be reduced.

In certain examples, the system 500 can use bootstrapped training, where prior determined data can be incorporated into a machine learning model 509 either prior to use or for training and/or updating the model 509. In some implementations, the system 500 is configured to train the machine learning model 509 with using manually driven data or expert data. In some implementations, the system 500 is configured to obtain (e.g., receive) the machine learning model 509 from a training environment (such as the training environment 800 of FIG. 8 and/or the training environment 900 of FIG. 9). In one or more embodiments or examples, the system 500 uses a planning system 520 (such as the planning system 404 of FIG. 4A) to determine a particular trajectory 513 of the autonomous vehicle to take.

As mentioned, in certain examples the system 500 is configured to obtain sensor data 504 from a sensor 503. For example, the sensor data 504 is associated with the environment in which a vehicle is operating. In other words, the sensor data 504 can be indicative of an environment (e.g., elements, such as agents, of the environment) around an autonomous vehicle. In one or more examples or embodiments, the system 500 obtains the sensor data 504 from a sensor 503 (e.g., one or more sensors). The sensor 503 can be an onboard sensor associated with the autonomous vehicle. For example, the sensor 503 is configured to provide sensor data 504 indicative of what is happening in the environment around the autonomous vehicle, such as for determining trajectories 510a of the autonomous vehicle. Sensors 503 can include one or more of the sensors illustrated in FIG. 2 (for example cameras 202a, LiDAR sensors 202b, radar sensors 202c, and/or microphones 202d). In certain examples, the sensor data includes data fused from various sensors. The fused data can contain the current state information about agents in the environment. In one or more examples or embodiments, the sensor data 504 is one or more of: radar data, camera data, image data, audio data, and LIDAR data. The particular type of sensor data 504 is not limited.

In one or more examples or embodiments, the environment includes one or more elements including one or more agents, such as a first agent. An agent can be construed as an object or actor in the environment capable of dynamic movement. Example agents include pedestrians, cyclists, other vehicles, etc. In some examples, the system 500 is configured to obtain sensor data 504 indicative of such elements/agents in the environment. As an alternative example, the system 500 obtains sensor data 504 indicative of no agents being in the environment. Accordingly, the system 500 can be configured to operate whether or not agents are present in the environment. In examples with no agents, the system 500 is still configured to extract and compute any homotopy data 508a (e.g., homotopy constraints) for operating the vehicle.

In some examples or embodiments, the sensor data 504 includes the vehicle's current state (e.g., a pose of the vehicle). In certain examples, the system obtains the pose data from the localization system (such as localization system 406 of FIG. 4A). For example, the sensor data 504 is localization sensor data. In one or more examples or embodiments, the sensor data 504 is indicative of one or more of: velocity, acceleration, steering angle, jerk, heading, angle, throttle, xyz coordinates or latitude/longitude coordinates representing a location, and angular acceleration of any agents in the environment, the autonomous vehicle itself, or both. The sensor data can include data fused from various sensors, such as fused sensor data of one or more agents. The fused sensor data can include one or more of: xyz position, heading, velocity, width, length, height, bounding box, convex hull, angular velocity, turn signals, pedestrian intent, and one or more uncertainties, such as position uncertainty, orientation uncertainty, and/or velocity uncertainty.

As mentioned, in certain examples the system 500 is configured to obtain route data 506a. For example, the system 500 obtains route data 506a from a route planner system 506. The route data 506a can be indicative of a route plan of the autonomous vehicle. For example, the route data 506a is indicative of the desired directions that the autonomous vehicle will follow to a particular destination. The route data 506a can include paths, including one or more alternate paths, between a starting location, an end location, and any intermediate locations. In some examples, a route plan indicated by the route data 506a is a lane-level route plan and/or a global route plan. In some cases, the route planner system 506 generates the route data 506a based on an origin location, destination location, and a map.

In one or more embodiments or examples, the system 500 is configured to determine element data associated with one or more elements of the environment based on the sensor data 504, such as a prediction 502a (e.g., first prediction) associated with an agent (e.g., a first agent). The system 500 can be configured to determine a prediction 502a for each agent in the environment. In examples where there is not a first agent, the system 500 may not be used to determine the prediction. The system 500 can use a prediction system 502 for determination of the prediction 502a. In some examples, the system 500 is configured to provide the prediction 502a to the homotopy extraction system 508 and optionally to other systems, such as the trajectory generator system 510 and/or the trajectory selector system 512. In certain embodiments, the system 500 determines the prediction 502a based on the sensor data 504. This can allow for “real-time” operation of the autonomous vehicle. In some examples, a prediction 502a (e.g., a first prediction) is seen as a prediction of a trajectory of an agent (e.g., the first agent). The prediction 502a may include a vector of agents, such as for a plurality of agents, where for each agent the prediction includes attributes. In some examples, attributes include one or more of a unique identification (ID), a timestamp where the agent is first seen, a class of the agents (e.g., pedestrian, cyclist, car), and a vector of future positions. For example, the future positions are a vector of future states (e.g., where the agent is likely to be located, a predicted trajectory of the agent for a time frame). The future position can be a particular time, for example 8 seconds from “current” time. The particular future time is not limiting, and different times can be used.

In one or more examples or embodiments, the system 500/homotopy extraction system 508 is configured to determine, using a machine learning model 509, homotopy data 508a based on the sensor data 504 and the route data 506a. The homotopy data 508a is associated with a homotopy from a first location to a second location associated with the route data 506a in some examples. In other words, the system 500 can be configured to extract a particular homotopy (or a plurality of homotopies).

A homotopy can be considered a mapping of space, such as region or area. For example, a homotopy can be indicative of a drivable corridor associated with a maneuver, e.g., from a first location to a second location (such as from a space around a first location to a space around a second location that corresponds to a section of the route). In this example, maneuvers can include operating a vehicle within a lane, switching between lanes, operating a vehicle through a turn, stopping or moving the vehicle from a location, and/or the like.

For example, the homotopy data 508a is indicative of passing decisions for each agent in the environment. In an example of an agent moving in the environment, the homotopy data 508a is indicative of the autonomous vehicle staying in front of the agent (e.g., passing before), staying behind the agent (e.g., passing after), and overtaking (e.g., to the left or the right of the agent). In some examples, a homotopy is a unimodal region from which an optimal trajectory realization is to be found.

In one or more examples or embodiments, the homotopy data 508a is associated with the route data 506a. For example, the system 500 may be configured to determine the homotopy data 508a based (e.g., using) on one or more of the sensor data 504, the route data 506a, and the one or more elements of the environment, such as prediction 502a (e.g., first prediction). In certain cases, the homotopy data 508a may correspond to a particular space or area within the route (e.g., the environment of the vehicle) over a period of time.

The homotopy data 508a includes constraint data 508b associated with one or more continuously differentiable parametric constraints based on the sensor data and the route data. Thus, in some examples or embodiments, the system 500 is configured to determine one or more constraints associated with a particular homotopy, such as a particular maneuver. For example, the homotopy data 508a may include constraints (represented by constraint data 508b) corresponding to a particular homotopy. In some cases, the homotopy may be in the form of two-dimensional space (e.g., having an x and y axis). In one or more examples, the system 500 can determine the homotopy data 508a by taking into account each agent (e.g., their location) and any corresponding predictions 502a (e.g., of their respective motion and/or action), when the system 500 determines that there is a plurality of agents present in the environment.

The constraints indicated by the constraint data 508b discussed herein can take a number of forms. In one or more examples, the constraint data 508b includes one or more spline representations, such as one or more B-splines. Thus, in one or more examples or embodiments, the system 500/homotopy extraction system 508 is configured to determine one or more spline representations, and the system 500 is configured to generate a trajectory based on the one or more spline representations. In one or more examples, the constraint data 508b includes one or more polynomial representations of one or more constraints. Thus, in one or more examples or embodiments, the system 500/homotopy extraction system 508 is configured to determine one or more polynomial representations of respective one or more constraints, and the system 500 is configured to generate and select a trajectory based on the one or more polynomial representations.

In one or more examples, the constraint data 508b includes one or more constraints associated with a maneuver. Thus, in one or more examples or embodiments, the system 500/homotopy extraction system 508 is configured to determine one or more constraints associated with a maneuver; and the system 500 is configured to generate and select a trajectory based on the maneuver.

In one or more examples, the one or more constraints includes a compulsory constraint (e.g., a hard constraint not to be violated) and/or a non-compulsory constraint (e.g., a soft constraint which can be violated in certain circumstances). Thus, in one or more examples or embodiments, the system 500/homotopy extraction system 508 is configured to determine a compulsory constraint and a non-compulsory constraint; and the system 500 is configured to generate and/or select the trajectory based on one or both of the compulsory constraints and the non-compulsory constraints. For example, the compulsory constraints and/or the non-compulsory constraints may include respective one or more lateral components (e.g., a left component and/or a right component) and/or one or more longitudinal components (e.g., a station start component and/or a station end component).

In certain examples, the constraint data 508b includes a spatio-temporal constraint. The spatio-temporal constraint may be seen as constraint applied to the lateral maneuver of the vehicle. In some examples, a spatio-temporal constraint is seen as a spatial maneuver description characterized (e.g., parameterized) by time and station (e.g., progress) and defined by an upper and lower lateral bound which the autonomous vehicle stays within. In one or more examples, the spatio-temporal constraint is a continuously differentiable parametric constraint, such as a B-spline or polynomial representation. In other words, the homotopy extraction system 508/machine learning model 509 can be configured to provide a spatio-temporal constraint being a B-spline or a polynomial representation as output/constraint data 508a.

In one or more examples, the system 500/homotopy extraction system 508 is configured to parameterize the spatio-temporal constraint, for example, by using a parameterized path representation. In some cases, the spatio-temporal constraint includes a series of temporally spaced spatial B-spline constraints. The desired trajectory realization duration may be in the range from 5 to 10 seconds, such as 8 seconds.

In certain examples, the constraint data 508b includes a station constraint. The station constraint may be seen as a constraint applied to the longitudinal maneuver of the vehicle. In some examples, a station constraint is seen as a station maneuver description characterized (e.g., parameterized) by time and defined by an upper and lower station bound which the autonomous vehicle stays within. This can be a constraint applied to the longitudinal maneuvering of the autonomous vehicle. In some examples, the station constraint is represented or described with the upper and lower bound value at each fixed timestep in the horizon/future. In some examples, one or more of the spatio-temporal constraint or the station constraint includes the compulsory and/or non-compulsory constraints.

In one or more examples, the system 500/homotopy extraction system 508 is configured to parameterize the station constraint, e.g., by temporally (equidistant) samples of the upper and lower bound, such as with a sampling interval and total duration matching the desired trajectory realization duration.

In one or more examples, the system 500/homotopy extraction system 508 is configured to perform a regression on the one or more constraints, such as on the parameterized spatio-temporal constraint and/or on the parameterized station constraint. In other words, to determine the homotopy data, the homotopy extraction system 508 may perform a regression on the one or more constraints.

In some examples, the system 500 is configured to parameterize the spatio-temporal constraint and/or the station constraint of the homotopy data 508a. For example, the station constraint may be parametrized by equidistant samples of the upper and lower bound, with a sampling interval and a total duration matching a desired trajectory realization duration. An example sampling interval is 8 seconds, though other intervals can be used as well. The machine learning model 509 can then be configured to output the homotopy data 508a/constraint data 508b.

In one or more examples or embodiments, the system 500 is configured to parameterize the spatio-temporal constraint using a parameterized path representation. The parameterized path representation may be a curve representation in certain implementations. In some examples, the spatio-temporal constraints are parameterized using basis splines (e.g., B-splines) with points (e.g., knots), which may or may not be equidistantly spaced. B-splines can be computationally efficient. One B-spline may be regressed for each of the bounds (left and right+hard and soft) for each timestep in the horizon. Each B-spline can be parameterized over station with lateral clearance as the value. Other options can be used instead of B-splines, for example, polynomial representation. In one or more examples, the system is configured to perform a regression on the one or more constraints indicated by the homotopy data 508a using the machine learning model 509. For example, the regression is performed on the parameterized spatio-temporal constraint and/or the parameterized station constraint. In some examples, the machine learning model 509 “learns” about the values of the buffer formed by the hard/compulsory and soft/non-compulsory constraints. In some cases, the learned regressor is the B-spline coefficients, which may be defined by the knot locations.

As shown in FIG. 5, the system 500, such as homotopy extraction system 508, can be configured to provide the homotopy data 508a including constraint data 508b to a trajectory generator system 510. In some examples, the trajectory generator system 510 determines one or more trajectories, such as a plurality of trajectories 510a, which may be possible for the autonomous vehicle to take based on the homotopy data 508a and/or the constraint data 508b included in the homotopy data. In certain cases, the trajectory generator system 510 may be implemented using one or more machine learning models (separate from the machine learning model 509). In some such cases, the machine learning models of the trajectory generator system 510 may be trained to generate one or more trajectories for one or more homotopies generated by the homotopy extraction system 508. For example, the trajectory generator system 510 may be trained to generate one or more trajectories using homotopy data and/or constraint data. In some cases, the trajectory generator system 510 may use additional data to generate the trajectories, such as sensor data 504, predictions 502a, and/or route data 506a. In certain cases, the machine learning model of the trajectory generator system 510 may be trained to generate one or more trajectories without using the homotopy data. For example, the machine learning model of the trajectory generator system 510 may be trained to generate one or more trajectories using the sensor data 504, predictions 502a, and/or the route data 506a.

In certain cases, the trajectory generator system 510 may generate one or more trajectories for each homotopy generated by/received from the homotopy extraction system 508. For example, for a particular homotopy generated by the homotopy extraction system 508, the trajectory generator system 510 may generate multiple trajectories that pass through the corridor corresponding to the homotopy. Each of the trajectories may vary in some way from the other. For example, the trajectories may vary in the turning radius, speed, acceleration, deceleration, position at a given time, etc., within the corridor corresponding to the homotopy.

Some or all of the trajectories generated by the trajectory generator system 510 may include operation data. The operation data can cause the vehicle to operate in a particular way. In other words, the system 500 can be configured to control operation of the autonomous vehicle using the operation data of a particular trajectory, such as by providing the operation data of the particular trajectory to the control system 516 (which can be the same or similar to control system 408 of FIG. 4A, such as for operation of the brake system 208, powertrain control system 204, and/or steering control system 206 of FIG. 2).

As described herein, by using the homotopy extraction system 508 (and machine learning model 509), the system 500 may generate fewer (and/or more accurate) homotopies for a particular time or environment. In some cases, the system 500 may generate only one homotopy at a particular time for a particular environment. This may result in the trajectory generator system 510 using fewer compute resources to generate (fewer) trajectories. This may enable the system 500 to use fewer compute resources overall and/or reallocate the compute resources used to generate more homotopies and/or trajectories to other tasks. For example, additional compute resource may be allocated to generating more precise and/or more accurate trajectories, improving predictions and/or controls, etc.

In some examples, the system 500 includes a trajectory selector system 512 which receives the plurality of trajectories 510a (e.g., generated by a trajectory generator system, such as trajectory generator system 510) and selects a trajectory 513 for operation of the autonomous vehicle. In some examples, the trajectory generator system 510 and the trajectory selector system 512 are integrated into a single system which receives the homotopy data 508a and provides the trajectory 513 for operation of the autonomous vehicle. Accordingly, the system 500 can be configured to select (e.g., choose) a trajectory 512a for the vehicle based on the homotopy data 508a. This can be performed after realization of the trajectory.

As mentioned, in one or more examples or embodiments, the system 500 is configured to select or determine a trajectory 513. The system 500 can be configured to select the trajectory 513 from a plurality of trajectories 510a. For example, the system 500 may be configured to select a trajectory 513 based on a cost analysis. In one or more examples or embodiments, the system 500 is configured to obtain manually driven data (e.g., driving data collected during navigation of vehicles), such as driving data associated with a human driver (for example, data collected when a human, such as expert driver, drives a vehicle), and select the trajectory 513 based on the driving data.

In one or more examples or embodiments, the system 500 can use a machine learning model 509 (e.g., as discussed with respect to the CNN 420 of FIGS. 4B-4D and/or using a recurrent neural network, and/or encoder-decoder transformer network) for determining and/or outputting certain parameters, such as homotopy data 508a/constraint data 508b. As such, the machine learning model 509 may include thousands, millions, or billions of nodes, some or all of which may be associated with a respective weighting value.

In some examples, the machine learning model 509 can be included in the homotopy extraction system 508. For example, the homotopy extraction system 508 may be configured to use a trained machine learning model 509 to determine the homotopy data 508a, such as constraint data 508b. In certain examples, the system 500 is configured to send the machine learning model 509 one or more of the predictions 502a (e.g., first prediction), sensor data 504, and route data 506a, and the machine learning model 509 uses the inputs to generate the homotopy data 508a and/or the constraint data 508b.

In some cases, the machine learning model 509 is implemented as an encoder-decoder based transformer network with an included attention mechanism that leverages the map (e.g., road infrastructure of the map stored in the database 410) as a prior (lane-to-actor attention) and attention between each agent and the ego vehicle (actor-to-ego attention). By encoding the agent information as temporal predictions, the attention mechanism of the encoding layer of the transformer can encode the relevant parts of the predictions, informed by, for example, the lane geometries, into the feature vectors.

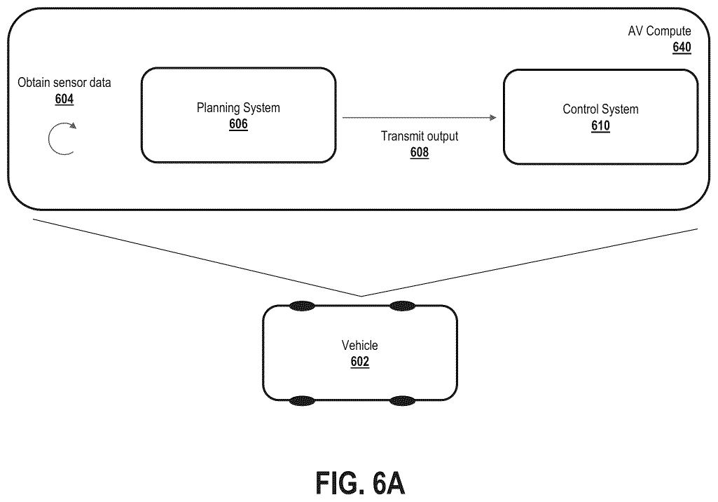

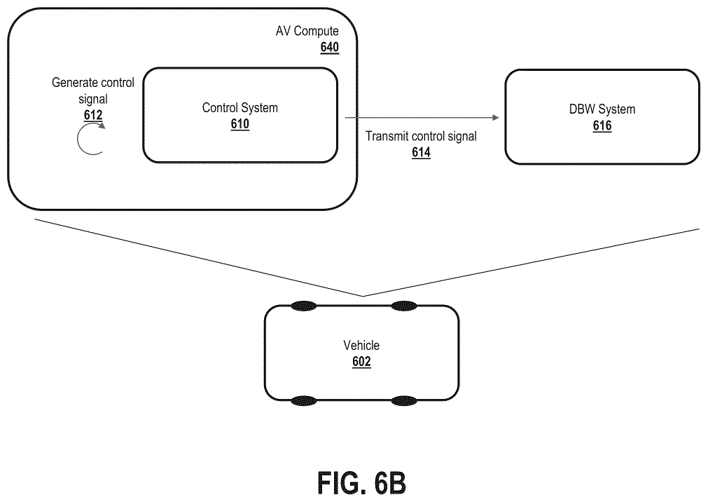

FIGS. 6A-6B illustrate an example implementation of a system for data-driven homotopy extraction (e.g., including any and/or all portion of the system 500 discussed with respect to FIG. 5). For example, the system is associated with a vehicle 602, such as an autonomous vehicle having an AV compute 640. In the example of FIG. 6A, the system obtains sensor data at step 604 (e.g., through one or more sensors on the vehicle 602). As discussed herein, the system can incorporate the sensor data into the planning system 606, which can then transmit an output at step 608 to a control system 610. In some examples, the output is operation data as discussed herein. Further, as shown in FIG. 6B, the system is configured to generate control signals at step 612, such as via control system 610. The system can then transmit the control signals at step 614 to a DBW system 616 (for example similar to DBW system 202h of FIG. 2) for operation of the vehicle 602.

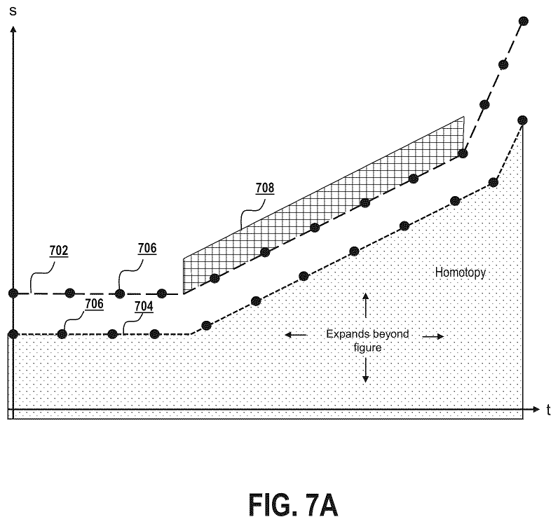

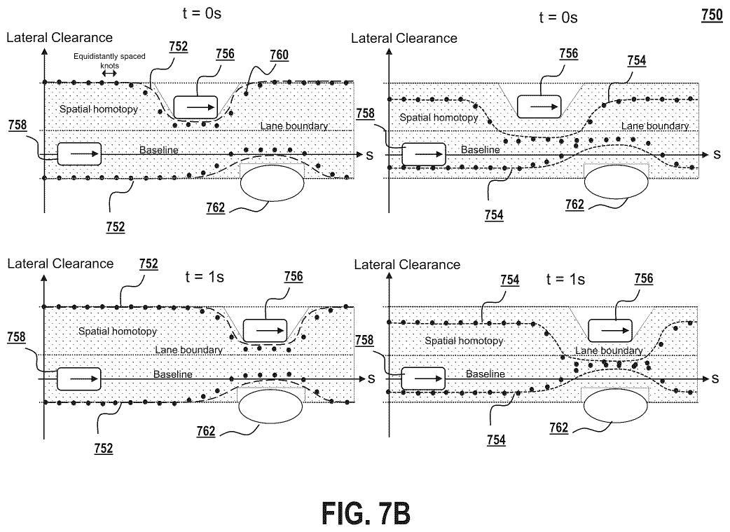

FIG. 7A illustrates an example of station-time constraints for a particular homotopy having a hard constraint 702 and a soft constraint 704. The constraints 702, 704 can be determined using equidistant samples (e.g., regressed points) 706 on both the upper and lower bounds. As shown, the hard constraint 702 can be formed by a spatio-temporal obstacle 708, such as a vehicle crossing into and then exiting the ego's lane, a leading vehicle, a jaywalker crossing the ego lane, and/or a stationary obstacle block the road, etc.

FIG. 7B illustrates an example of spatio-temporal constraints for a particular homotopy for an autonomous vehicle 758 operating within an environment. As shown, the environment can include both agents 756 (e.g., another vehicle, cyclist, pedestrian, etc.) and obstacles 762 (e.g., stationary object, such as construction signs or dividers, parked vehicle, object in the road, etc.).

The constraints shown in the left-side diagrams of FIG. 7B illustrate hard constraints 752 (e.g., e.g., road dividers, non-drivable areas, etc.) and the constraints shown in the right-side diagrams of FIG. 7B illustrate soft constraints 754 (e.g., threshold distance from hard constraints, etc.).

The constraints shown in the top diagrams illustrate the constraints at a time of Os whereas the bottom diagrams illustrate the constraints at a time of 1s into the future. The constraints 752, 754 can be formed by regressed B-spline knots 760, which may be equidistant.

FIG. 8 is a diagram illustrating an example of an environment 800 for training a machine learning model. In one or more examples, the machine learning model trained in the environment 800 may be included in a planning system or other component of an AV compute.

In the illustrated example, the environment 800 includes a database 802, training planning system 840, a machine learning model 812, and a loss calculation system 842. By way of example, the machine learning model 812 may use training data received from the database 802 to generate and select homotopies, and the training planning system 840 may use the training data from the database 802 to generate and select training trajectories (and training homotopies corresponding to the training trajectories). The loss calculation system 852 may use the training data, the homotopy data, training trajectories, and training homotopies to calculate one or more losses for the machine learning model 812. The calculated losses may be used to modify one or more parameters and/or weights of the machine learning model 812.

The database 802 may be implemented using one or more data stores and can include training data 803 associated with one or more training scenarios, predictions, and/or training goals for the machine learning model 812. In some cases, the training data 803 may correspond to data captured and/or generated by one or more autonomous vehicles driving the various environments and/or data generated by a machine learning model trained to generate training scenarios. In certain cases, the database 802 may include training data 803 corresponding to thousands, millions, billions or more training scenarios. In some such cases, each training scenario may include different environments (e.g., different locations, different objects, different agents) at different times.

In some cases, the training data 803 may include information relating to a route and/or a particular environment over a period of time (e.g., the location of the environment, the drivable and non-drivable areas of the environment, agents and objects in the environment, etc.). In this way, the training data 803 may simulate a particular environment of a route over a period of time for the machine learning model 812 and/or the training planning system 840.

The training data 803 may include route data corresponding to a drivable route for a vehicle, object data corresponding to one or more objects in an environment, agent data corresponding to one or more agents in the environment, prediction data corresponding to predictions for the one or more agents, and ego data corresponding to an autonomous vehicle (e.g., position, orientation, velocity, acceleration, etc. of the ego vehicle). The object data may indicate one or more of a class or type of one or more object within the environment, as well as the location and/or orientation of the objects. The agent data may indicate a class or type of one or more agents in the environment and one or more of a position, orientation, velocity, and/or acceleration of the agents. The prediction data may indicate one or more predictions for the agents in the environment, similar to the prediction 502a.

The training planning system 840 may be configured to use the training data 803 to extract homotopies, generate trajectories, and score and select a trajectory. In the illustrated example, the training planning system 840 includes a route planner system 804, homotopy extractor 806, trajectory generator 808 and/or a trajectory selector 809. Some or all of the components of the training planning system 840 may be implemented using one or more processors.

The route planner system 804 may be similar to the route planner system 506 and be configured to generate a route using a starting location (origin), ending location (destination), and a map.

The homotopy extractor 806 may be configured to generate one or more homotopies based on the training data 803 and/or the first route data 805. In some cases, the homotopy extractor 806 generates the homotopies using a tree search and/or does not include a machine learning model. For example, in the training environment 800, there may not be a time constraint for generating the homotopies. As such, the homotopy extractor 806 may take considerable time to generate homotopies based on the training data 803 and/or the first route data 805.

The trajectory generator(s) 808 may generate one or more trajectories based on the homotopies generated by the homotopy extractor 806. In some cases, the trajectory generator(s) 808 may be similar to the trajectory generator system 510 and generate one or more trajectories for each homotopy generated by the homotopy extractor 806. As described herein, as the homotopy extractor 806 may generate many homotopies, there may be multiple trajectory generator(s) 808 to generate corresponding trajectories for some or all of the homotopies. Moreover, in the training environment 800, there may be fewer or no time constraints thereby enabling the trajectory generator(s) 808 to spend more time generating more (and detailed) trajectories.

The trajectory selector 809 may be similar to the trajectory selector system 512 and may be configured to score the generated trajectories and select a trajectory based on the scores. For example, the trajectory selector system 512 may select the trajectory with the highest score. In some cases, the training environment may not include a control system or autonomous vehicle. For example, the output of the training planning system 840 may be used to train the machine learning model 812 (rather than to control a vehicle).

The machine learning model 812 may be similar to the machine learning model 509 before it is trained (or between trainings), and may be implemented using one or more neural networks, such as an encoder-decoder transformer network or other neural network and configured to generate and select homotopy data using training data and route data. As such, the machine learning model 812 may include thousands, millions, or billions of nodes, some or all of which may be associated with a respective weighting value.

As described herein the components in the training environment 800 may be used to train the machine learning model 812. In some cases, the machine learning model 812 may be a multi-modality trained machine learning model that is trained using different training modalities (or different training techniques). For example, a first training or first training modality may use the output of the training planning system 840 to train the machine learning model 812 (also referred to as a bootstrapped training) and a second training or second training modality may use manually driven data (data collected during navigation of vehicles) as shown and described herein at least with reference to FIG. 9. In some cases, the first training may occur prior to the second training, such that a machine learning model trained according to the first training modality is further (or subsequently) trained using the second training modality.

As part of the first training or bootstrap training, the training planning system 840 may use the training data 803 to generate multiple homotopies (e.g., using the homotopy extractor 806) and trajectories (e.g., using the trajectory generator(s) 808) corresponding to the multiple homotopies and select a homotopy (e.g., using the homotopy extractor 806 and/or trajectory selector 809) and/or trajectory (e.g., using the trajectory selector 809) from the generated homotopies and trajectories, respectively. In addition, the training planning system 840 may generate or provide first route data 805 (e.g., using the route planner system 804) based on the training data 803.

The trajectory selected by the training planning system 840 (e.g., selected trajectory) may also be referred to herein as the first training trajectory 810 and may be used by the loss calculation system 842 to calculate one or more losses for the machine learning model 812.

The homotopy that corresponds to the selected trajectory (e.g., the homotopy used to generate the selected trajectory) and/or the homotopy selected by the training planning system 840 may also be referred to herein as the selected homotopy. Moreover, the homotopy data corresponding to the selected homotopy may also be referred to herein as the training homotopy data 811. In some cases, the training homotopy data 811 may be included as part of the first training trajectory 810. In certain cases, the training homotopy data 811 may be separate from the first training trajectory 810. Some or all of the training homotopy data 811 (e.g., the parametric station constraints from the selected homotopy and/or the parametric spatio-temporal constraints from the selected homotopy) may be used by the loss calculation system 842 to calculate one or more losses for the machine learning model 812.

The machine learning model 812 may also use the training data 803 and/or the first route data 805 to generate and select a homotopy. The homotopy data corresponding to the homotopy selected by the machine learning model 812 may also be referred to as the first homotopy data 813. In some cases, the machine learning model 812 may generate the first homotopy data 813 after or concurrently with the training planning system 840 generating the first training trajectory 810 and/or the training homotopy data 811.

The first homotopy data 813 may include any one or any combination of the data described herein with reference to the homotopy data 508a. For examiner the first homotopy data 813 may include first station constraints 813a (e.g., first predicted parameterized station constraints) and/or first spatio-temporal constraints 813b (e.g., a first predicted parameterized spatio-temporal constraints). In some cases, the first homotopy data 813, may indicate the contours or location of the corridor in which the vehicle may traverse through the environment and/or include soft constraints and/or hard constraints. In certain cases, the first homotopy data 813 may correspond to a homotopy associated with the first training trajectory 810. For example, the first training trajectory 810 may indicate a trajectory through (or otherwise associated with) the homotopy that corresponds to the training homotopy data 811.

The loss calculation system 842 may be implemented using one or more processors and may be configured to calculate one or more losses based on (e.g., using) the output of the machine learning model 812 and the output of the training planning system 840.

In the illustrated example, the loss calculation system 842 uses the training data 803, the first training trajectory 810, the training homotopy data 811 (e.g., first training station constraint 811a and/or first training spatio-temporal constraint 811b), and the first homotopy data 813 (e.g., first station constraint 813a and/or first spatio-temporal constraint 813b), to calculate various losses (e.g., agent clearance loss 815, homotopy loss 817, spatio-temporal constraint regression loss 819, station constraint regression loss 821) for the machine learning model 812.

The losses may be used to train the machine learning model 812. For example, based on the calculated losses, one or more parameters or weights of the machine learning model 812 may be adjusted. The training process of calculating losses and using the losses to adjust the parameters or weights of the machine learning model 812 may be repeated thousands, millions, billions or more times using different training scenarios and/or training data 803 until the machine learning model 812 is determined to be sufficiently trained (and/or until the training data 803 is exhausted). For example, the training process may be repeated until one or more of the losses calculated by the loss calculation system 842 satisfies a respective loss threshold (e.g., is less than a particular threshold number).

In some cases, the loss calculation system 842 may calculate an agent clearance loss 815 using the training data 803, the first station constraint 813a, the first spatio-temporal constraint 813b, and an agent clearance loss function 814. In some cases, the loss calculation system 842 uses agent data (e.g., from the training data 803) corresponding to one or more agents in the environment and the first homotopy data 813 to calculate the agent clearance loss 815. For example, the loss calculation system 842 may compare the location of the agents (e.g., using the agent data) with the location of the ego (e.g., using the first homotopy data 813) to determine whether the distance between them satisfies a distance threshold (e.g., if the ego traversed the homotopy corresponding to the first homotopy data 813). In one or more examples, the agent clearance loss 815 includes an L2 loss on the distance between ego and agent boundaries.

In some cases, the loss calculation system 842 may calculate a trajectory-within-homotopy loss 817 (e.g., for the selected trajectory within the selected homotopy) using the first station constraint 813a, the first spatio-temporal constraint 813b, the first training trajectory 810, and a trajectory-within-homotopy loss function 816. As part of the trajectory-within-homotopy loss function 816, the loss calculation system 842 may compare one or more parameters of the first training trajectory 810 (e.g., the selected trajectory) with the first station constraint 813a and the first spatio-temporal constraint 813b. In one or more examples, the trajectory-within-homotopy loss 817 can be a log-barrier on each of the trajectory states (e.g., of the first training trajectory 810) satisfying the homotopy constraints (e.g., the first station constraint 813a and/or the first spatio-temporal constraint 813b).

In some cases, the loss calculation system 842 may calculate a spatio-temporal constraint regression loss 819 using the first spatio-temporal constraint 813b, the first training spatio-temporal constraint 811b and a spatio-temporal constraint loss function 818. In some cases, the first training spatio-temporal constraint 811b may include a parametric spatio-temporal constraint of a homotopy associated with the first training trajectory 810 and/or the first spatio-temporal constraint 813b may include a first predicted parameterized spatio-temporal constraint.

As part of the spatio-temporal constraint loss function 818, the loss calculation system 842 may compare the first training spatio-temporal constraint 811b to the first spatio-temporal constraint 813b. In some such cases, the loss calculation system 842 may calculate the spatio-temporal constraint loss 819 based on the difference between the first training spatio-temporal constraint 811b and the first spatio-temporal constraint 813b. For example, the difference may be calculated by calculating the distance at select spatio-temporal locations along the two B-splines (e.g., a B-spline corresponding to first training spatio-temporal constraint 811b and a B-spline corresponding to the first spatio-temporal constraint 813b).

In some cases, the loss calculation system 842 may calculate a station constraint regression loss 821 using the first station constraint 813a, the first training station constraint 811a, and a station constraint loss function 820. In some cases, the first training station constraint 811a may include a parametric station constraint of a homotopy associated with the first training trajectory 810 and/or the first station constraint 813a may include a predicted parameterized station constraint.

As part of the station constraint loss function 820, the loss calculation system 842 may compare the first station constraint 813a to the first training station constraint 811a. In some such cases, the loss calculation system 842 may calculate the station constraint loss 821 based on the difference between the first station constraint 813a and the first training station constraint 811a.

FIG. 9 is a diagram illustrating a training environment 900 to perform a (second) training for a machine learning model, such as the machine learning model 812. In this way, the machine learning model may be a multi-modality trained machine learning model. In one or more examples, the machine learning model 812 trained in the environment 900 may be included in a planning system or other component of an AV compute. I

In the illustrated example, the environment 900 includes a database 902, the machine learning model 812, and a loss calculation system 942. The machine learning model 812 may use training data 903 received from the database 902 to generate and select second homotopy data 913 corresponding to one or more homotopies generated by the machine learning model 812. The loss calculation system 942 may use the training data 903, the selected second homotopy data 913, and training trajectories 910 to calculate losses for the machine learning model 812. The calculated losses may be used to modify one or more parameters and/or weights of the machine learning model 812.

The database 902 may be similar to the database 802 described herein at least with reference to FIG. 8 and may include training data 903. The training data 903 may include similar data as that described herein with reference to the training data 803.

The database 902 may also include route data 905. The route data 905 may be similar to the first route data 805 in that it may include data corresponding to a start point, end point, and a drivable route between the two points. The route data 905 may include a global route plan and/or a lane-level route plan.

In the illustrated example of FIG. 9, the database 902 may also include training trajectories 910 and/or training homotopies (not shown). The training trajectories 910 may include data similar to the data included in the first training trajectory 810. For example, the training trajectories 910 may include operation data associated with particular actions (e.g., steer left or right, accelerate, etc.) that the autonomous vehicle is to take at particular times to navigate through an environment for a particular amount of time (e.g., for the next eight seconds) and/or indicate a particular path through the environment.

In some cases, the training trajectories 910 may differ from the first training trajectory 810 in that the first training trajectory 810 may correspond to a trajectory generated and selected by the training planning system 840, whereas the training trajectories 910 may correspond to a manually driven data. For example, the training trajectory may correspond to manually driven trajectories (e.g., trajectories obtained by monitoring a vehicle during navigation by a human (or autonomously) and/or identified as an “expert driven” trajectory).

In some cases, the training trajectories 910 may be generated by tracking or monitoring vehicles as they navigate (under human control or other) a particular path through a particular environment. Various parameters may be extracted from the particular path and identified as the trajectory. It will be understood that the database 902 may include thousands, millions, billions, or more training trajectories 910 corresponding to various trajectories collected by monitoring thousands, millions, or more vehicles.

As described herein, the machine learning model 812 may be implemented using one or more neural networks, such as an encoder-decoder transformer network or other network and configured to generate and select second homotopy data 913 using training data 903 and route data 905. Similar to the first homotopy data 813, the second homotopy data 913 may also include station constraints 913a (e.g., predicated parameterized station constraints) and/or spatio-temporal constraints 913b (e.g., predicted parameterized spatio-temporal constraints). The homotopy data 913 may be used by a trajectory generator to generate trajectories for an autonomous vehicle to navigate a particular environment.

The loss calculation system 942 may be similar to the loss calculation system 842 and include one or more processors configured to calculate one or more losses for the machine learning model 812 based on the training data 903, the second homotopy data 913 from the machine learning model 812 and the training trajectories 904. The loss calculation system 942 may calculate any one or any combination of the losses described herein with reference to the loss calculation system 842. Accordingly, the loss calculation system may use any one or any combination of the training data 903, second homotopy data 913, and/or training trajectory 910 to calculate one or more losses.

For simplicity, FIG. 9 illustrates only an agent clearance loss and a selected trajectory-within-homotopy loss. In some cases, the loss calculation system 942 may calculate a subset of the losses (or use a subset of the loss functions to calculate the second losses or second loss parameters) in the second training as compared to the losses (or first loss parameters) calculated in the first training.

In some cases, the loss calculation system 942 may calculate an agent clearance loss 915 similar to the agent clearance loss 815. For example, the loss calculation system 942 may calculate an agent clearance loss 915 using the training data 903, first station constraint of the second homotopy data 913, first spatio-temporal constraint of the second homotopy data 913, and an agent clearance loss function 914. In one or more examples, the agent clearance loss 915 includes an L2 loss on the distance between ego and agent boundaries.

In some cases, the loss calculation system 942 may calculate a trajectory-within-homotopy loss 917 (e.g., for the selected trajectory within the selected homotopy) similar to the trajectory-within-homotopy loss 817. For example, the loss calculation system 942 may calculate the trajectory-within-homotopy loss 917 using the first station constraint of the second homotopy data 913, the first spatio-temporal constraint of the second homotopy data 913, the first training trajectory 910, and a trajectory-within-homotopy loss function 916. As part of the trajectory-within-homotopy loss function 916, the loss calculation system 942 may compare one or more parameters of the first training trajectory 910 (e.g., the selected trajectory) with the second station constraint of second homotopy data 913 and the second spatio-temporal constraint of the second homotopy data 913. In one or more examples, the trajectory-within-homotopy loss 917 can be a log-barrier on each of the trajectory states satisfying the homotopy constraints.

In some cases, the machine learning model 812 may be trained in the training environment 800 as part of a first training and trained further in the training environment 900 as part of a second training. In this way, the machine learning model 812 may be a multi-modality trained machine learning model that is trained using different training modalities.

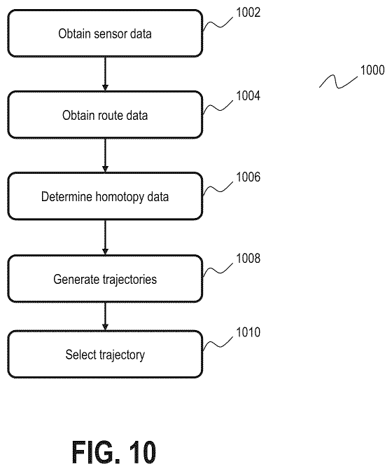

FIG. 10 is a flow diagram illustrating an example of a method or process 1000 for homotopy extraction. The process 1000 can be performed by a system disclosed herein, such as an AV compute 202f of FIG. 2 and AV compute 400 of FIG. 4A, a vehicle 102, 200, of FIGS. 1 and 2, respectively, device 300 of FIG. 3, and AV compute 540 of FIG. 5, and implementations of FIGS. 6A-6B, and 7A-7B. The system disclosed can include at least one processor which can be configured to carry out one or more of the operations of process 1000. The process 1000 can be performed (e.g., completely, partially, and/or the like) by another device or group of devices separate from or including system disclosed herein.

At block 1002, the system obtains sensor data associated with an environment in which a vehicle (e.g., autonomous vehicle) is operating. As described herein, the sensor data may include image data associated with a camera, lidar data associated with a lidar system, semantic data associated with a perception system, such as perception system 402, etc. In some examples, the sensor data identifies or can be used to identify one or more agents (e.g., a first agent) within the environment.

At block 1004, the system obtains route data indicative of a route plan. As described herein, the route plan can indicate the general route of the autonomous vehicle from a starting location to a particular destination. For example, the route can indicate the total distance of the route, the roads to use and/or the turns to make (e.g., left, right, and/or U-turns) to arrive at the destination. In some cases, the route may indicate a preferred lane for the vehicle, such as left-turn lane, right-turn lane, or an exit lane (e.g., to exit a particular road, highway, or freeway). However, in some cases, the route data may not or does not include instructions as to whether to stay in a particular lane at any given moment, when to change lanes, how to effectuate a lane change or turn (e.g., speed of lane change, speed of the turn, radius of the turn), speed of the vehicle, whether to accelerate or decelerate, etc.

At block 1006, the system determines (or generates) homotopy data based on the sensor data, the route data, and/or agent data. As described herein, the agent data may correspond to one or more agents in the environment of the vehicle and may be determined based on the sensor data. In some cases, the agent data may include one or more predictions corresponding to respective agents in the environment (e.g., a first prediction corresponding to a first agent in the environment).

As described herein, the system may use a machine learning model (e.g., machine learning model 509 and/or machine learning model 812) to generate the homotopy data. In some cases, prior to generating the homotopy data (e.g., during an inference mode), the machine learning model may be trained in the manner described herein at least with reference to FIGS. 8, 9, and/or 11. As such, the machine learning model may be a multi-modality trained machine learning model.

The homotopy data may be associated with a homotopy from a first location to a second location associated with the route data (e.g., corresponding to a particular portion of the route). As described herein, a homotopy may include a mapping of space over a period of time, such as a region or area of the vehicle's environment, and a particular (drivable) corridor through that space. For example, a homotopy may include a mapping of an intersection that the vehicle is about to enter and a corridor through which the vehicle could pass to navigate through the intersection in a safe manner (e.g., without a collision). In some such cases, the first location may correspond to one location on one side of the intersection (e.g., location before the vehicle passes through the intersection) and the second location may correspond to another location on another side of the intersection (e.g., location after the vehicle has passed through the intersection).

In some cases, to move through the indicated corridor, the vehicle may make one or more maneuvers (e.g., turns, lane changes, steering/acceleration adjustments, etc.). The homotopy data may define the contours (e.g., shape or area of the homotopy) or other information of the homotopy and/or otherwise indicate the drivable corridor through the particular space. In some cases, the homotopy data is associated with the route data in that the homotopy data corresponds to a particular corridor within a particular space or location that is traversed as the vehicle follows the route to the indicated destination.

In some cases, the (generated) homotopy data includes constraint data associated with one or more constraints. Accordingly, the system may generate constraint data as part of the homotopy data.

In certain cases, the constraints include one or more continuously differentiable parametric constraints. In some cases, the constraints include one or more compulsory constraints and/or non-compulsory constraints. Some or all of the compulsory constraints and/or non-compulsory constraints may include lateral components and/or longitudinal components.

In certain cases, the constraints include spatio-temporal constraints and/or station constraints. The spatio-temporal constraints may include one or more B-spline constraints, such as one or more (optionally equidistant) knots. Accordingly, the system may generate a spline representation of a constraint. In certain cases, the system may perform a regression on the one or more constraints, such as a regression on a parameterized spatio-temporal constraint and/or on a parameterized station constraint. In some cases, the system may generate a polynomial representation of a constraint.

At block 1008, the system generates at least one trajectory based on the homotopy data (generated by the machine learning model 509). As described herein the system may generate one or more trajectories for some or all homotopies generated by the system (e.g., by the homotopy extractor 806). In some cases, the system generates multiple trajectories for a particular homotopy.

At block 1010, the system selects a trajectory for use in controlling the vehicle. As described herein, the selected trajectory may include operation data to cause the vehicle to operate in accordance with the trajectory.

Fewer, more, or different blocks may be included as part of the process 1000. In some cases, the process 1000 may include operating the vehicle using the trajectory. For example, the operation data may include one or more instructions for one or more components of the vehicle to take certain actions. In some cases, these actions may include adjusting the steering wheel, accelerator, and/or brake, etc. As another example, the generation and selection of a trajectory may occur concurrently.

It will be understood that the process 1000 may be repeated hundreds, thousands, or millions of times as a vehicle navigates along a route (or within an environment along the route). In some cases, the process 1000 may be repeated multiple times per second.

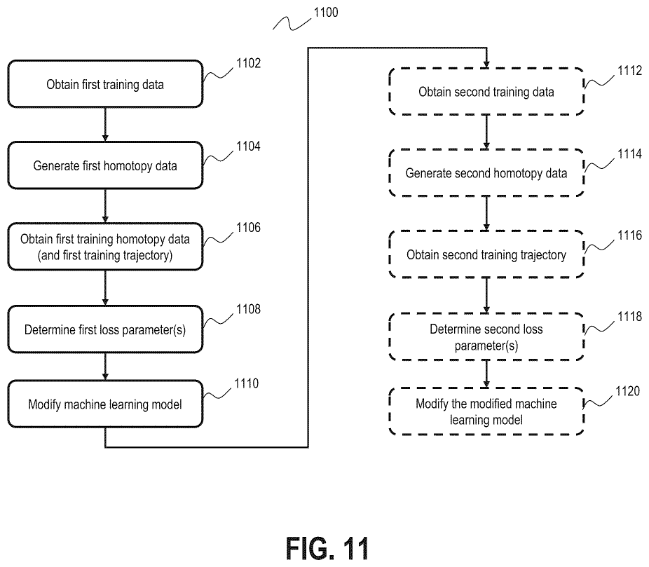

FIG. 11 is a flow diagram illustrating an example of a method or process 1100 for training a machine learning model to perform data-driven homotopy extraction. The process 1100 can be performed by one or more processors or components disclosed herein. The process 1000 can be performed (e.g., completely, partially, and/or the like) by any one or any combination of devices separate from or including the systems disclosed herein.

At block 1102, the system obtains first training data (e.g., training data 803) associated with an environment. As described herein, the training data 803 may include data corresponding to a particular environment (e.g., space or area) over a period of time and may include object data corresponding to one or more objects in the environment over the period of time, agent data corresponding to one or more agents in the environment over the period of time, road data corresponding to drivable regions within the environment, and ego data corresponding to the ego vehicle over the period of time, etc.

At block 1104, the system generates, using a machine learning model (e.g., machine learning model 812), first homotopy data (e.g., first homotopy data 813) based on the training data 803. As described herein, the machine learning model 812 can be configured to generate homotopy data (e.g., first station constraint 813a and/or first spatio-temporal constraint 813b) based on the training data 803 and/or route data 805. As described herein, the training data may include agent data and/or object data. As such, the machine learning model 812 may use the agent data and/or object data to generate the first homotopy data 813.

At block 1106, the system obtains first training homotopy data (e.g., training homotopy data 811) and/or a first training trajectory (e.g., first training trajectory 810). As described herein, the first training homotopy data may be generated by a training planning system 840. For example, the training planning system 840 may include a homotopy extractor 806 configured to generate homotopies based on the training data 803 and/or the first route data 805 and select a homotopy from the generated homotopies (e.g., a homotopy corresponding to a selected trajectory). As described herein, the training homotopy data 811 may include first training station constraints (e.g., parametric station constraints) from the selected homotopy), and/or first training spatio-temporal constraints (e.g., parametric spatio-temporal constraints) from the selected homotopy). As described herein, the system may also obtain a training trajectory (e.g., first training trajectory 810). The first training trajectory 810 may be associated with the first training homotopy data. For example, the first training homotopy data may correspond to a homotopy in which the first training trajectory is located.

Moreover, the training planning system 840 may include one or more trajectory generator(s) 808 and trajectory selector 809 configured generate and select a trajectory to be used as the first training trajectory 810.

At block 1108, the system determines at least one first loss parameter. As described herein, the first loss parameter(s) may be calculated using the training data 803, the first training trajectory 810, training homotopy data 811, and/or the first homotopy data 813. For example, the loss calculation system 842 may calculate any one or any combination of the agent clearance loss 815, the trajectory-within-homotopy loss 817, the spatio-temporal constraint regression loss 819, and/or the station constraint regression loss 821, using various combinations of the training data 803, the first training trajectory 810, the training homotopy data 811, and/or the first homotopy data 813. For example, the system may use agent data or training data and the first homotopy data to calculate the agent clearance loss 815; the first training trajectory and the first homotopy data to calculate the trajectory-within-homotopy loss 817; the first homotopy data and a (parametric) spatio-temporal constraint of the training homotopy data to calculate the spatio-temporal constraint regression loss 819; and the first homotopy data and a (parametric) station constraint of the training homotopy data to calculate the station constraint regression loss 821.

At block 1110, the system modifies the machine learning model 812 based on the at least one first loss parameter. As described herein, to modify the machine learning model, the system may modify one or more parameters or weights of the machine learning model and/or the nodes of the machine learning model based on the at least one first loss parameter. For example, the system may modify one or more parameters or weights of the machine learning model and/or the nodes of the machine learning model based on any one or any combination of the agent clearance loss 815, the trajectory-within-homotopy loss 817, the spatio-temporal constraint regression loss 819, and/or the station constraint regression loss 821. In this way, the machine learning model 812 may be trained. In some cases, the parameters and/or weights of the machine learning model 812 are modified to reduce or eliminate the loss parameters (or losses) in subsequent training scenarios.

As described herein, the blocks 1102-1110 may be repeated thousands, millions, or billions of times using different training data (e.g., different training scenarios) so that the machine learning model 812 is trained using various scenarios and environments. It will be understood that with different training data, the machine learning model 812 may generate different first homotopy data 813 and the training planning system 840 may generate different first training trajectories 810 and different training homotopy data 811.

Fewer, more, or different blocks may be included in the process 1100. For example, as described herein blocks, 1102-1110 may correspond to a first training and the resulting machine learning model (or first modality trained machine learning model) may be further trained as part of a second training using a second training modality. In some cases, the second training modality uses expert driven trajectories (e.g., from manually driven data sets) to train the machine learning model instead of or in addition to training-planning-system-generated trajectories.

At block 1112, the system obtains second training data associated with a second route (or route plan). The second training data may include similar types of data as the first training data but have different values for the data (corresponding to a different training environment or scenario).

At block 1114, the system generates, using the (modified) machine learning model (e.g., first modality trained machine learning model), second homotopy data based on the second training data. As described herein the machine learning model can generate homotopy data in a similar way as described herein with reference to block 1104. It will be noted, however, that the weight and parameters of the machine learning model during the second training may be different than the weight and parameters of the machine learning model during the first training (given that the weights and/or parameters have been adjusted over time). Given the differences, if confronted with the same data during the first training and the second training would generate different homotopy data. Thus, the second homotopy data generated during the second training is different from the first homotopy data generated during the first training.

At block 1116, the system obtains a second training trajectory associated with the second route. As described herein, the second training trajectory may correspond to a manually driven trajectory from manually driven data. As described herein, the second training trajectory may come from a database and correspond to a trajectory followed by a vehicle (e.g., when a person was driving) and/or a trajectory used by an autonomous vehicle (e.g., and identified as an expert driven trajectory).

At block 1118, the system determines at least one second loss parameter based on the second homotopy data and the second training trajectory. As described herein, the second loss parameter(s) can be determined in a manner similar to the first loss parameters. For example, the system may use any one or any combination of training data 903, second homotopy data 913, training trajectories 910 and/or training homotopy data, to determine losses (e.g., loss parameters) for the (modified) machine learning model 812.

As described herein the various losses may be calculated using respective loss functions. In some cases, the loss functions used to calculate the second loss parameters may be a subset of the loss functions used to calculate the first loss parameters.

At block 1120, the system modifies the (modified) machine learning model based on the second loss parameters. As described herein at least with reference to block 1110, modifying the machine learning model may include modifying one or more weights or parameters of the machine learning model 812 (or nodes thereof). In some cases, the system modifies the weights or parameters to reduce or eliminate the calculated loss(es) or loss parameters. The resulting (or generated) machine learning model may also be referred to as a second modality trained machine learning model.

In some cases, such as when the machine learning model is trained using multiple modalities (e.g., the first training described herein with reference to blocks 1102 and the second training described herein with reference to blocks 1112-1120, and/or potentially other modalities), the resulting machine learning model may also be referred to as a multi-modality trained machine learning model.

Fewer, more, or different blocks may be added to 1100. Moreover, the blocks may be performed in a different order. For example, the machine learning model may first be trained using blocks 1112-1120 (first training) and then trained according to blocks 1102-1110 (second training). In some cases, the first training may be completed before performing the second training. In certain cases, the first training and second training may occur concurrently.

### Example Items

Disclosed are non-transitory computer-readable media comprising instructions stored thereon that, when executed by at least one processor, cause the at least one processor to carry out operations according to one or more of the methods disclosed herein.

Also disclosed are methods, non-transitory computer-readable media, and systems according to any of the following items:
Item 1. A method, comprising:
   obtaining, using at least one processor, first training data associated with a first route;
   performing, using the at least one processor, a first training comprising:
      generating, using the at least one processor and a machine learning model, first homotopy data based on the first training data, wherein the first homotopy data is associated with an environment corresponding to a portion of the first route;
      obtaining, using the at least one processor, at least one of first training homotopy data or a first training trajectory;
      determining, using the at least one processor and at least one first loss function, at least one first loss parameter based on the first homotopy data and the at least one of the first training homotopy data or the first training trajectory; and
      modifying, using the at least one processor, the machine learning model based on the at least one first loss parameter.
Item 2. The method of item 1, further comprising:
   performing, using the at least one processor, a second training comprising:
      obtaining, using the at least one processor, second training data associated with a second route;
      generating, using the at least one processor and the modified machine learning model, second homotopy data based on the second training data, wherein the second homotopy data is associated with a second environment corresponding to a portion of the second route;
      obtaining, using the at least one processor, a second training trajectory associated with the second route;
      determining, using the at least one processor and at least one second loss function, at least one second loss parameter including a second loss parameter based on the second homotopy data and the second training trajectory; and
      modifying, using the at least one processor, the modified machine learning model based on the at least one second loss parameter.
Item 3. The method of item 2, wherein the at least one second loss function is a subset of the at least one first loss function.
Item 4. The method of any of items 1-3:
   wherein the first training data comprises agent data associated with at least one agent in an environment,
   wherein generating the first homotopy data comprises generating the first homotopy data based on the agent data,
   wherein determining the at least one first loss parameter comprises determining an agent clearance loss based on the agent data and the first homotopy data, and
   wherein training the machine learning model based on the at least one first loss parameter comprises training the machine learning model based on the agent clearance loss.
Item 5. The method of any of items 1-4, wherein determining at least one first loss parameter comprises determining a trajectory-within-homotopy loss based on the first homotopy data and the first training trajectory, and
   wherein training the machine learning model based on the at least one first loss parameter comprises training the machine learning model based on the trajectory-within-homotopy loss.
Item 6. The method of any of items 5, wherein determining at least one first loss parameter comprises determining a station constraint regression loss based on the first homotopy data and a parametric station constraint of the first training homotopy data, wherein the first training homotopy data is associated with the first training trajectory, and
   wherein training the machine learning model based on the at least one first loss parameter comprises training the machine learning model based on the station constraint regression loss.
Item 7. The method of any of items 5-6, wherein determining at least one first loss parameter based on first training data comprises determining a spatio-temporal constraint regression loss based on the first homotopy data and a parametric spatio-temporal constraint of the first training homotopy data, wherein the first training homotopy data is associated with the first training trajectory, and
   wherein training the machine learning model based on the at least one first loss parameter comprises training the machine learning model based on the spatio-temporal constraint regression loss.
Item 8. A system, comprising:
   at least one processor; and
   at least one non-transitory computer-readable medium storing instructions that, when executed by the at least one processor, cause the at least one processor to perform operations including:
   obtaining first training data associated with a first route;
   performing a first training comprising:
      generating using a machine learning model, first homotopy data based on the first training data, wherein the first homotopy data is associated with an environment corresponding to a portion of the first route;
      obtaining at least one of first training homotopy data or a first training trajectory;
      determining and at least one first loss function, at least one first loss parameter based on the first homotopy data and the at least one of the first training homotopy data or the first training trajectory; and
      modifying the machine learning model based on the at least one first loss parameter.
Item 9. The system of item 8, wherein the operations further comprise:
   performing a second training comprising:
      obtaining second training data associated with a second route;
      generating and the modified machine learning model, second homotopy data based on the second training data, wherein the second homotopy data is associated with a second environment corresponding to a portion of the second route;
      obtaining a second training trajectory associated with the second route;
      determining and at least one second loss function, at least one second loss parameter including a second loss parameter based on the second homotopy data and the second training trajectory; and
      modifying the modified machine learning model based on the at least one second loss parameter.
Item 10. The system of item 9, wherein the at least one second loss function is a subset of the at least one first loss function.
Item 11. The system of any of items 8-10:
   wherein the first training data comprises agent data associated with at least one agent in the first environment,
   wherein generating the first homotopy data comprises generating the first homotopy data based on the agent data,
   wherein determining the at least one first loss parameter comprises determining an agent clearance loss based on the agent data and the first homotopy data, and
   wherein training the machine learning model based on the at least one first loss parameter comprises training the machine learning model based on the agent clearance loss.
Item 12. The system of any of items 8-11, wherein determining at least one first loss parameter comprises determining a trajectory-within-homotopy loss based on the first homotopy data and the first training trajectory, and
   wherein training the machine learning model based on the at least one first loss parameter comprises training the machine learning model based on the trajectory-within-homotopy loss.
Item 13. The system of any of items 12, wherein determining at least one first loss parameter comprises determining a station constraint regression loss based on the first homotopy data and a parametric station constraint of the first training homotopy data, wherein the first training homotopy data is associated with the first training trajectory, and
   wherein training the machine learning model based on the at least one first loss parameter comprises training the machine learning model based on the station constraint regression loss.
Item 14. The system of any of items 12-13, wherein determining at least one first loss parameter based on first training data comprises determining a spatio-temporal constraint regression loss based on the first homotopy data and a parametric spatio-temporal constraint of the first training homotopy data, wherein the first training homotopy data is associated with the first training trajectory, and
   wherein training the machine learning model based on the at least one first loss parameter comprises training the machine learning model based on the spatio-temporal constraint regression loss.
Item 15. A non-transitory computer-readable medium storing instructions that, when executed by at least one processor, cause the at least one processor to perform operations including:
   obtaining first training data associated with a first route;
   performing a first training comprising:
      generating, using a machine learning model, first homotopy data based on the first training data, wherein the first homotopy data is associated with an environment corresponding to a portion of the first route;
      obtaining at least one of first training homotopy data or a first training trajectory;
      determining and at least one first loss function, at least one first loss parameter based on the first homotopy data and the at least one of the first training homotopy data or the first training trajectory; and
      modifying the machine learning model based on the at least one first loss parameter.
Item 16. The non-transitory computer-readable medium of item 15, wherein the operations further comprise:
   performing a second training comprising:
      obtaining second training data associated with a second route;
      generating and the modified machine learning model, second homotopy data based on the second training data, wherein the second homotopy data is associated with a second environment corresponding to a portion of the second route;
      obtaining a second training trajectory associated with the second route;
      determining and at least one second loss function, at least one second loss parameter including a second loss parameter based on the second homotopy data and the second training trajectory; and
      modifying the modified machine learning model based on the at least one second loss parameter.
Item 17. The non-transitory computer-readable medium of item 16, wherein the at least one second loss function is a subset of the at least one first loss function.
Item 18. The non-transitory computer-readable medium of any of items 15-17:
   wherein the first training data comprises agent data associated with at least one agent in the first environment,
   wherein generating the first homotopy data comprises generating the first homotopy data based on the agent data,
   wherein determining the at least one first loss parameter comprises determining an agent clearance loss based on the agent data and the first homotopy data, and
   wherein training the machine learning model based on the at least one first loss parameter comprises training the machine learning model based on the agent clearance loss.
Item 19. The non-transitory computer-readable medium of any of items 15-18, wherein determining at least one first loss parameter comprises determining a trajectory-within-homotopy loss based on the first homotopy data and the first training trajectory, and
   wherein training the machine learning model based on the at least one first loss parameter comprises training the machine learning model based on the trajectory-within-homotopy loss.
Item 20. The non-transitory computer-readable medium of any of items 19, wherein determining at least one first loss parameter comprises determining a station constraint regression loss based on the first homotopy data and a parametric station constraint of the first training homotopy data, wherein the first training homotopy data is associated with the first training trajectory, and
   wherein training the machine learning model based on the at least one first loss parameter comprises training the machine learning model based on the station constraint regression loss.
Item 21. The non-transitory computer-readable medium of any of items 19-20, wherein determining at least one first loss parameter based on first training data comprises determining a spatio-temporal constraint regression loss based on the first homotopy data and a parametric spatio-temporal constraint of the first training homotopy data, wherein the first training homotopy data is associated with the first training trajectory, and
   wherein training the machine learning model based on the at least one first loss parameter comprises training the machine learning model based on the spatio-temporal constraint regression loss.

Also disclosed are methods, non-transitory computer-readable medium, and systems according to any of the following items:
Item 1. A method, comprising:
   obtaining, using at least one processor, sensor data associated with an environment in which a first vehicle is operating;
   obtaining, using the at least one processor, route data associated with a route plan;
   determining, using a machine learning model, homotopy data based on the sensor data and the route data, wherein the homotopy data comprises constraint data and wherein the homotopy data is associated with a homotopy from a first location to a second location, wherein the first location and the second location are associated with the route data; and
   generating, using the at least one processor, operation data associated with the homotopy data to cause the first vehicle to operate.
Item 2. The method of item 1, wherein the constraint data is associated with at least one continuously differentiable parametric constraint.
Item 3. The method of any of items 1 or 2, wherein determining homotopy data comprises determining at least one spline representation of respective at least one constraint of the constraint data; and generating operation data comprises generating the operation data based on the at least one spline representation.
Item 4. The method of item 3, wherein determining at least one spline representation comprises determining at least one B-spline; and wherein providing operation data comprises providing the operation data based on the at least one B-spline.
Item 5. The method of any of items 1-4, wherein determining homotopy data comprises determining at least one polynomial representation of respective at least one constraint of the constraint data; and wherein providing operation data comprises providing the operation data based on the at least one polynomial representation.
Item 6. The method of any of items 1-5, further comprising:
   determining, using the at least one processor, agent data associated with at least one agent of the environment based on the sensor data; and
   wherein determining homotopy data comprises determining the homotopy data based on the sensor data, the route data, and the at least one agent of the environment.
Item 7. The method of item 6, wherein determining agent data comprises determining a first prediction associated with a first agent of the environment; and
wherein determining homotopy data comprises determining the homotopy data based on the first agent.
Item 8. The method of any of items 1-7, wherein determining homotopy data comprises determining at least one constraint associated with a maneuver; and wherein generating operation data comprises generating the operation data based on the maneuver.
Item 9. The method of item 8, wherein determining the homotopy data comprises determining a compulsory constraint and a non-compulsory constraint; and
   wherein generating operation data comprises generating the operation data based on at least one of the compulsory constraint or the non-compulsory constraint.
Item 10. The method of item 9, wherein determining the compulsory constraint comprises determining at least one of at least one lateral component or at least one longitudinal component; and
   wherein generating operation data comprises generating the operation data based on at least one of at least one lateral component of the compulsory constraint or at least one longitudinal component of the compulsory constraint.
Item 11. The method of any of items 9-10, wherein determining the non-compulsory constraint comprises determining at least one of at least one lateral component or at least one longitudinal component; and
   wherein generating operation data comprises generating the operation data based on at least one of at least one lateral component of the non-compulsory constraint or at least one longitudinal component of the non-compulsory constraint.
Item 12. The method of any of items 9-11, wherein determining the homotopy data comprises determining at least one of a spatio-temporal constraint or a station constraint; and
   wherein generating the operation data comprises generating the operation data based on the at least one of spatio-temporal constraint or the station constraint.
Item 13. The method of any of items 8-12, wherein determining the homotopy data comprises performing a regression on at least one constraint of the constraint data.
Item 14. The method of any of items 1-13, wherein the machine learning model is a multi-modality trained machine learning model trained using at least one first training trajectory as part of a first training modality and at least one second training trajectory as part of a second training modality, wherein the at least one first training trajectory is generated by a training planning system, and wherein the at least one second training trajectory is generated by monitoring at least one other vehicle during navigation.
Item 15. The method of any of items 1-13, wherein the machine learning model is a multi-modality trained machine learning model trained using a first training and a second training,
   wherein the first training includes:
      calculating at least one first loss parameter based on first homotopy data generated by the machine learning model and first training homotopy data generated by a homotopy extractor of a training planning system that is distinct from the machine learning model, and
      modifying the machine learning model based on the at least one first loss parameter to form a first modality trained machine learning model;
   wherein the second training includes:
      calculating at least one second loss parameter based on second homotopy data generated by the first modality trained machine learning model and at least one second training trajectory, wherein the at least one second training trajectory corresponds to data collected during navigation of at least one second vehicle, and
      generating the multi-modality trained machine learning model based on at least one modification to the first modality trained machine learning model, wherein the at least one modification is based on the at least one second loss parameter.
Item 16. A system, comprising:
   at least one processor; and
   at least one non-transitory computer-readable medium storing instructions that, when executed by the at least one processor, cause the at least one processor to perform operations including:
   obtaining sensor data associated with an environment in which a vehicle is operating;
   obtaining route data associated with a route plan;
   determining, using a machine learning model, homotopy data based on the sensor data and the route data, wherein the homotopy data comprises constraint data associated with at least one continuously differentiable parametric constraint and wherein the homotopy data is associated with a homotopy from a first location to a second location, wherein the first location and the second location are associated with the route data; and
   generating operation data associated with the homotopy data to cause the vehicle to operate.
Item 17. The system of item 16, wherein the constraint data is associated with at least one continuously differentiable parametric constraint.
Item 18. The system of any of items 16 or 17, wherein determining homotopy data comprises determining at least one spline representation of respective at least one constraint of the constraint data; and generating operation data comprises generating the operation data based on the at least one spline representation.
Item 19. The system of item 18, wherein determining at least one spline representation comprises determining at least one B-spline; and wherein providing operation data comprises providing the operation data based on the at least one B-spline.
Item 20. The system of any of items 16-19, wherein determining homotopy data comprises determining at least one polynomial representation of respective at least one constraint of the constraint data; and wherein providing operation data comprises providing the operation data based on the at least one polynomial representation.
Item 21. The system of any of items 16-20, further comprising:
   determining agent data associated with at least one agent of the environment based on the sensor data; and
   wherein determining homotopy data comprises determining the homotopy data based on the sensor data, the route data, and the at least one agent of the environment.
Item 22. The system of item 21, wherein determining agent data comprises determining a first prediction associated with a first agent of the environment; and
wherein determining homotopy data comprises determining the homotopy data based on the first agent.
Item 23. The system of any of items 16-22, wherein determining homotopy data comprises determining at least one constraint associated with a maneuver; and wherein generating operation data comprises generating the operation data based on the maneuver.
Item 24. The system of item 23, wherein determining the homotopy data comprises determining a compulsory constraint and a non-compulsory constraint; and
   wherein generating operation data comprises generating the operation data based on at least one of the compulsory constraint or the non-compulsory constraint.
Item 25. The system of item 24, wherein determining the compulsory constraint comprises determining at least one of at least one lateral component or at least one longitudinal component; and
   wherein generating operation data comprises generating the operation data based on at least one of at least one lateral component of the compulsory constraint or at least one longitudinal component of the compulsory constraint.
Item 26. The system of any of items 24-25, wherein determining the non-compulsory constraint comprises determining at least one of at least one lateral component or at least one longitudinal component; and
   wherein generating operation data comprises generating the operation data based on at least one of at least one lateral component of the non-compulsory constraint or at least one longitudinal component of the non-compulsory constraint.
Item 27. The system of any of items 24-26, wherein determining the homotopy data comprises determining at least one of a spatio-temporal constraint or a station constraint; and
   wherein generating the operation data comprises generating the operation data based on the at least one of spatio-temporal constraint or the station constraint.
Item 28. The system of any of items 16-27, wherein determining the homotopy data comprises performing a regression on at least one constraint of the constraint data.
Item 29. The system of any of items 16-28, wherein the machine learning model is a multi-modality trained machine learning model trained using at least one first training trajectory as part of a first training modality and at least one second training trajectory as part of a second training modality, wherein the at least one first training trajectory is generated by a training planning system, and wherein the at least one second training trajectory is generated by monitoring at least one other vehicle during navigation.
Item 30. The system of any of items 16-29, wherein the machine learning model is a multi-modality trained machine learning model trained using a first training and a second training,
   wherein the first training includes:
      calculating at least one first loss parameter based on first homotopy data generated by the machine learning model and first training homotopy data generated by a homotopy extractor of a training planning system that is distinct from the machine learning model, and
      modifying the machine learning model based on the at least one first loss parameter to form a first modality trained machine learning model;
   wherein the second training includes:
      calculating at least one second loss parameter based on second homotopy data generated by the first modality trained machine learning model and at least one second training trajectory, wherein the at least one second training trajectory corresponds to data collected during navigation of at least one second vehicle, and
      generating the multi-modality trained machine learning model based on at least one modification to the first modality trained machine learning model, wherein the at least one modification is based on the at least one second loss parameter.
Item 31. A non-transitory computer-readable medium storing instructions that, when executed by at least one processor, cause the at least one processor to perform operations including:
   obtaining sensor data associated with an environment in which a vehicle is operating;
   obtaining route data associated with a route plan;
   determining, using a machine learning model, homotopy data based on the sensor data and the route data, wherein the homotopy data comprises constraint data associated with at least one continuously differentiable parametric constraint and wherein the homotopy data is associated with a homotopy from a first location to a second location, wherein the first location and the second location are associated with the route data; and
   generating operation data associated with the homotopy data to cause the vehicle to operate.
Item 32. The non-transitory computer-readable medium of item 31, wherein the constraint data is associated with at least one continuously differentiable parametric constraint.
Item 33. The non-transitory computer-readable medium of any of items 31 or 32, wherein determining homotopy data comprises determining at least one spline representation of respective at least one constraint of the constraint data; and
generating operation data comprises generating the operation data based on the at least one spline representation.
Item 34. The non-transitory computer-readable medium of item 33, wherein determining at least one spline representation comprises determining at least one B-spline; and wherein providing operation data comprises providing the operation data based on the at least one B-spline.
Item 35. The non-transitory computer-readable medium of any of items 31-34, wherein determining homotopy data comprises determining at least one polynomial representation of respective at least one constraint of the constraint data; and wherein providing operation data comprises providing the operation data based on the at least one polynomial representation.
Item 36. The non-transitory computer-readable medium of any of items 31-35, further comprising:
   determining agent data associated with at least one agent of the environment based on the sensor data; and
   wherein determining homotopy data comprises determining the homotopy data based on the sensor data, the route data, and the at least one agent of the environment.
Item 37. The non-transitory computer-readable medium of item 36, wherein determining agent data comprises determining a first prediction associated with a first agent of the environment; and wherein determining homotopy data comprises determining the homotopy data based on the first agent.
Item 38. The non-transitory computer-readable medium of any of items 31-37, wherein determining homotopy data comprises determining at least one constraint associated with a maneuver; and wherein generating operation data comprises generating the operation data based on the maneuver.
Item 39. The non-transitory computer-readable medium of item 38, wherein determining the homotopy data comprises determining a compulsory constraint and a non-compulsory constraint; and
   wherein generating operation data comprises generating the operation data based on at least one of the compulsory constraint or the non-compulsory constraint.
Item 40. The non-transitory computer-readable medium of item 39, wherein determining the compulsory constraint comprises determining at least one of at least one lateral component or at least one longitudinal component; and
   wherein generating operation data comprises generating the operation data based on at least one of at least one lateral component of the compulsory constraint or at least one longitudinal component of the compulsory constraint.
Item 41. The non-transitory computer-readable medium of any of items 39-40, wherein determining the non-compulsory constraint comprises determining at least one of at least one lateral component or at least one longitudinal component; and
   wherein generating operation data comprises generating the operation data based on at least one of at least one lateral component of the non-compulsory constraint or at least one longitudinal component of the non-compulsory constraint.
Item 42. The non-transitory computer-readable medium of any of items 39-41, wherein determining the homotopy data comprises determining at least one of a spatio-temporal constraint or a station constraint; and
   wherein generating the operation data comprises generating the operation data based on the at least one of spatio-temporal constraint or the station constraint.
Item 43. The non-transitory computer-readable medium of any of items 31-42, wherein determining the homotopy data comprises performing a regression on at least one constraint of the constraint data.
Item 44. The non-transitory computer-readable medium of any of items 31-43, wherein the machine learning model is a multi-modality trained machine learning model trained using at least one first training trajectory as part of a first training modality and at least one second training trajectory as part of a second training modality, wherein the at least one first training trajectory is generated by a training planning non-transitory computer-readable medium, and wherein the at least one second training trajectory is generated by monitoring at least one other vehicle during navigation.
Item 45. The non-transitory computer-readable medium of any of items 31-44, wherein the machine learning model is a multi-modality trained machine learning model trained using a first training and a second training,
   wherein the first training includes:
      calculating at least one first loss parameter based on first homotopy data generated by the machine learning model and first training homotopy data generated by a homotopy extractor of a training planning non-transitory computer-readable medium that is distinct from the machine learning model, and
      modifying the machine learning model based on the at least one first loss parameter to form a first modality trained machine learning model;
   wherein the second training includes:
      calculating at least one second loss parameter based on second homotopy data generated by the first modality trained machine learning model and at least one second training trajectory, wherein the at least one second training trajectory corresponds to data collected during navigation of at least one second vehicle, and
      generating the multi-modality trained machine learning model based on at least one modification to the first modality trained machine learning model, wherein the at least one modification is based on the at least one second loss parameter.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

What is claimed is:

1. A method, comprising:
obtaining, using at least one processor, first training data associated with a first route; and
performing, using the at least one processor, a first training comprising:
generating, using the at least one processor and a machine learning model, first homotopy data based on the first training data, wherein the first homotopy data is associated with a first environment corresponding to a portion of the first route;
obtaining, using the at least one processor, at least one of first training homotopy data or a first training trajectory;
determining, using the at least one processor and at least one first loss function, at least one first loss parameter based on the first homotopy data and the at least one of the first training homotopy data or the first training trajectory; and
modifying, using the at least one processor, the machine learning model based on the at least one first loss parameter.

2. The method of claim 1, further comprising:
performing, using the at least one processor, a second training comprising:
obtaining, using the at least one processor, second training data associated with a second route;
generating, using the at least one processor and the modified machine learning model, second homotopy data based on the second training data, wherein the second homotopy data is associated with a second environment corresponding to a portion of the second route;
obtaining, using the at least one processor, a second training trajectory associated with the second route;
determining, using the at least one processor and at least one second loss function, at least one second loss parameter including a second loss parameter based on the second homotopy data and the second training trajectory; and
modifying, using the at least one processor, the modified machine learning model based on the at least one second loss parameter.

3. The method of claim 2, wherein the at least one second loss function is a subset of the at least one first loss function.

4. The method of claim 1,
wherein the first training data comprises agent data associated with at least one agent in the first environment,
wherein generating the first homotopy data comprises generating the first homotopy data based on the agent data,
wherein determining the at least one first loss parameter comprises determining an agent clearance loss based on the agent data and the first homotopy data, and
wherein training the machine learning model based on the at least one first loss parameter comprises training the machine learning model based on the agent clearance loss.

5. The method of claim 1, wherein determining at least one first loss parameter comprises determining a trajectory-within-homotopy loss based on the first homotopy data and the first training trajectory, and
wherein training the machine learning model based on the at least one first loss parameter comprises training the machine learning model based on the trajectory-within-homotopy loss.

6. The method of claim 5, wherein determining at least one first loss parameter comprises determining a station constraint regression loss based on the first homotopy data and a parametric station constraint of the first training homotopy data, wherein the first training homotopy data is associated with the first training trajectory, and
wherein training the machine learning model based on the at least one first loss parameter comprises training the machine learning model based on the station constraint regression loss.

7. The method of claim 5, wherein determining at least one first loss parameter based on first training data comprises determining a spatio-temporal constraint regression loss based on the first homotopy data and a parametric spatio-temporal constraint of the first training homotopy data, wherein the first training homotopy data is associated with the first training trajectory, and
wherein training the machine learning model based on the at least one first loss parameter comprises training the machine learning model based on the spatio-temporal constraint regression loss.

8. A method, comprising:
obtaining, using at least one processor, sensor data associated with an environment in which a first vehicle is operating;
obtaining, using the at least one processor, route data associated with a route plan;
determining, using a machine learning model, homotopy data based on the sensor data and the route data, wherein the homotopy data comprises constraint data and wherein the homotopy data is associated with a homotopy from a first location to a second location, wherein the first location and the second location are associated with the route data; and
generating, using the at least one processor, operation data associated with the homotopy data to cause the first vehicle to operate.

9. The method of claim 8, wherein the constraint data is associated with at least one continuously differentiable parametric constraint.

10. The method of claim 8, wherein determining homotopy data comprises determining at least one spline representation of respective at least one constraint of the constraint data; and generating operation data comprises generating the operation data based on the at least one spline representation.

11. The method of claim 10, wherein determining at least one spline representation comprises determining at least one B-spline; and wherein providing operation data comprises providing the operation data based on the at least one B-spline.

12. The method of claim 8, wherein determining homotopy data comprises determining at least one polynomial representation of respective at least one constraint of the constraint data; and wherein providing operation data comprises providing the operation data based on the at least one polynomial representation.

13. The method of claim 8, wherein the method comprises:
determining, using the at least one processor, agent data associated with at least one agent of the environment based on the sensor data; and
wherein determining homotopy data comprises determining the homotopy data based on the sensor data, the route data, and the at least one agent of the environment.

14. The method of claim 13, wherein determining agent data comprises determining a first prediction associated with a first agent of the environment; and wherein determining homotopy data comprises determining the homotopy data based on the first agent.

15. The method of claim 8, wherein determining homotopy data comprises determining at least one constraint associated with a maneuver; and wherein generating operation data comprises generating the operation data based on the maneuver.

16. The method of claim 15, wherein determining the homotopy data comprises determining a compulsory constraint and a non-compulsory constraint; and
wherein generating operation data comprises generating the operation data based on at least one of the compulsory constraint or the non-compulsory constraint.

17. The method of claim 16, wherein determining the compulsory constraint comprises determining at least one of at least one lateral component or at least one longitudinal component; and
wherein generating operation data comprises generating the operation data based on at least one of at least one lateral component of the compulsory constraint or at least one longitudinal component of the compulsory constraint.

18. The method of claim 16, wherein determining the non-compulsory constraint comprises determining at least one of at least one lateral component or at least one longitudinal component; and
wherein generating operation data comprises generating the operation data based on at least one of at least one lateral component of the non-compulsory constraint or at least one longitudinal component of the non-compulsory constraint.

19. The method of claim 16, wherein determining the homotopy data comprises determining at least one of a spatio-temporal constraint or a station constraint; and
wherein generating the operation data comprises generating the operation data based on the at least one of spatio-temporal constraint or the station constraint.

20. The method of claim 15, wherein determining the homotopy data comprises performing a regression on at least one constraint of the constraint data.

21. The method of claim 8, wherein the machine learning model is a multi-modality trained machine learning model trained using at least one first training trajectory as part of a first training modality and at least one second training trajectory as part of a second training modality, wherein the at least one first training trajectory is generated by a training planning system, and wherein the at least one second training trajectory is generated by monitoring at least one other vehicle during navigation.

22. The method of claim 8, wherein the machine learning model is a multi-modality trained machine learning model trained using a first training and a second training,
wherein the first training includes:
calculating at least one first loss parameter based on first homotopy data generated by the machine learning model and first training homotopy data generated by a homotopy extractor of a training planning system that is distinct from the machine learning model, and
modifying the machine learning model based on the at least one first loss parameter to form a first modality trained machine learning model;
wherein the second training includes calculating at least one second loss parameter based on second homotopy data generated by the first modality trained machine learning model and a second training trajectory, wherein the second training trajectory corresponds to data collected during navigation of at least one second vehicle, and
generating the multi-modality trained machine learning model based on at least one modification to the first modality trained machine learning model, wherein the at least one modification is based on the at least one second loss parameter.

23. A system, comprising:
at least one processor; and
at least one non-transitory computer-readable medium storing instructions that, when executed by the at least one processor, cause the at least one processor to perform operations including:
obtaining sensor data associated with an environment in which a vehicle is operating;
obtaining route data associated with a route plan;
determining, using a machine learning model, homotopy data based on the sensor data and the route data, wherein the homotopy data comprises constraint data associated with at least one continuously differentiable parametric constraint and wherein the homotopy data is associated with a homotopy from a first location to a second location, wherein the first location and the second location are associated with the route data; and
generating operation data associated with the homotopy data to cause the vehicle to operate.
